(19) United States
(12) Patent Application Publication
(10) Pub. No.: US 2026/0230433 A1
(43) Pub. Date: Aug. 6, 2026

(54) USING RELATIVE IMPORTANCE IN ASSOCIATION WITH A PDU SESSION

(71) Applicant: InterDigital Patent Holdings, Inc., Wilmington, DE (US)

(72) Inventors: Michael Starsinic, Newtown, PA (US); Xavier De Foy, Kirkland (CA); Jaya Rao, Montreal (CA); Magurawalage Chathura Madhusanka Sarathchandra, London (GB); Achref Methenni, Montreal (CA)

(73) Assignee: InterDigital Patent Holdings, Inc., Wilmington, DE (US)

(21) Appl. No.: 19/153,268

(22) PCT Filed: Feb. 2, 2024
(86) PCT No.: PCT/US2024/014244

§ 371 Date: Aug. 1, 2025

Related U.S. Application Data
(60) Provisional application No. 63/442,938, filed on Feb. 2, 2023.

(51) Int. Cl. H04L 47/2441; H04L 47/32

(52) U.S. Cl. CPC H04L 47/2441; H04L 47/32

(57) ABSTRACT

Systems, methods, and instrumentalities are disclosed for a session management function (SMF) determining relative protocol data unit (PDU) set importance within a quality of service (QoS) flow. A first network node (e.g., an SMF) may detect a triggering event. The first network node may send, to a first wireless transmit receive unit (WTRU), a first message. The first message may include a first protocol data unit (PDU) set assignment rule corresponding to a quality of service (QoS) flow. The first PDU set assignment rule may indicate a first PDU set base value and a discard factor. The first network node may send, to a second network node, a second message. The second message may include a second PDU set assignment rule associated with the QoS flow. The first network node may send, to a third network node, a third message including a QoS profile that indicate the discard factor.

### CROSS-REFERENCE TO RELATED APPLICATIONS

This application claims the benefit of U.S. Provisional Application No. 63/442,938, filed Feb. 2, 2023, the contents of which is incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed for a session management function (SMF) determining relative protocol data unit (PDU) set importance within a quality of service (QoS) flow. A first network node (e.g., an SMF) may detect a triggering event. The first network node may send, to a first wireless transmit receive unit (WTRU), a first message. The first message may include a first protocol data unit (PDU) set assignment rule corresponding to a quality of service (QoS) flow. The first PDU set assignment rule may indicate a first PDU set base value and a discard factor. The first network node may send, to a second network node, a second message. The second message may include a second PDU set assignment rule associated with the QoS flow. The second PDU set assignment rule may indicate a second PDU set base value. The first network node may send, to a third network node, a third message.

The third message may include a QoS profile. The QoS profile may indicate the discard factor. The discard factor may correspond to the QoS flow.

The second PDU set assignment rule may include a PDU set reset trigger indicating a condition. Based on the condition being satisfied, the first network node may assign the second PDU set base value as the PDU set value of a downlink PDU. Based on the condition being satisfied, the first network node may assign the first PDU set base value as the PDU set value of a downlink PDU.

The triggering event may be associated with one or more of a PDU session establishment request, a PDU session modification request, or receiving policy and charging control (PCC) rules.

The first message may include a non-access stratum (NAS) message. The NAS message may correspond to one or more of a PDU session establishment accept message or a PDU session modification command message.

The first PDU set assignment rule may include a first PDU set importance (PDSI) assignment rule. The second PDU set assignment rule may include a second PDSI assignment rule. The first PDU set base value may include a first PDSI base value. The second PDU set base value may include a second PDSI base value.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 illustrates an example of handling PDU set importance in a PDU session.

### DETAILED DESCRIPTION

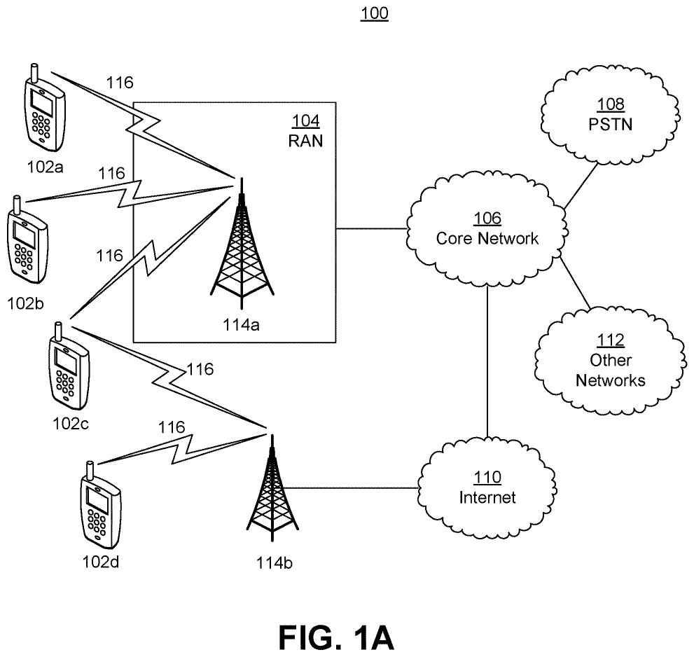

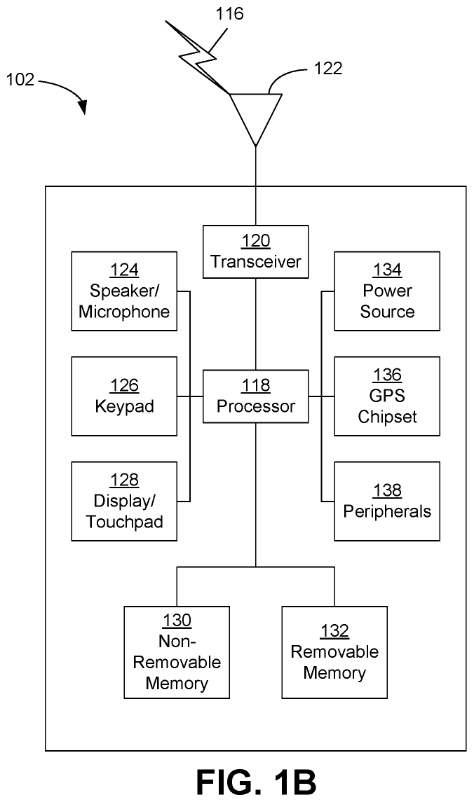

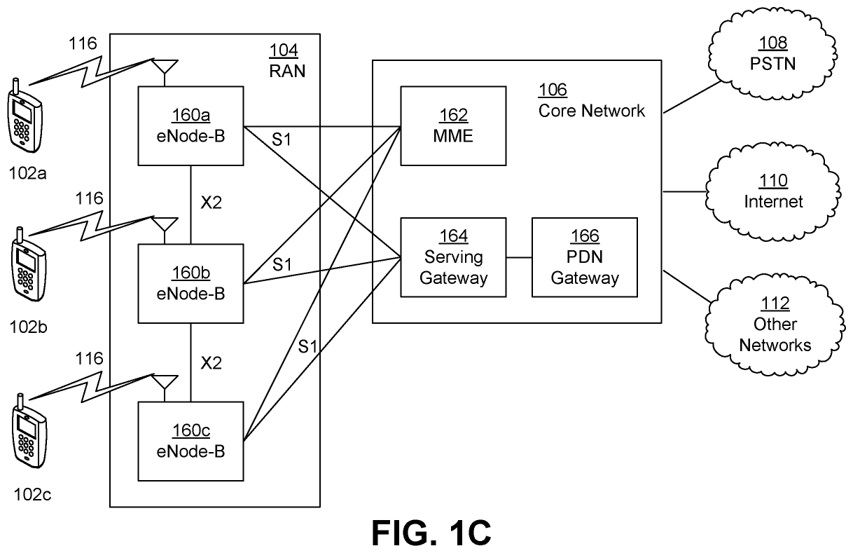

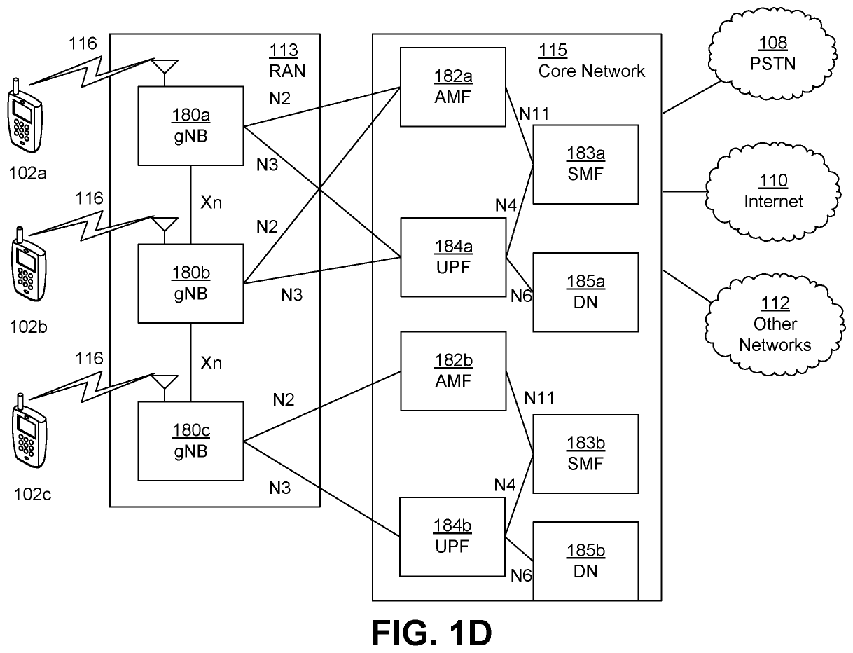

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Features described herein may be associated with PDU sets. A PDU set may be one or more PDUs carrying the payload of one unit of information generated at the application level (e.g., a frame or video slice for extended reality (XR) services).

PDU set importance may be an importance of a PDU set within a QoS flow. The NG-RAN may use the PDU set importance for PDU set level packet discarding in presence of congestion. PDU set information may be different for different PDU sets within a QoS flow. A mechanism may not be defined for how and whether PDU set importance is interpreted across QoS flow. A mechanism may not be defined for how the WTRU and RAN determine when to use PDU set importance to make packet discarding decisions, when to use a QoS flow priority level to make packet discarding decisions, and when to use a combination of PDU set importance and a QoS flow priority level to make packet discarding decisions.

Features described herein may be associated with QoS flows. A UPF may assign downlink packets to a QoS flow based on rules (e.g., N4 rules) that are configured in the UPF by the SMF. The WTRU may assign uplink packets to a QoS flow based on QoS rules that are configured in the WTRU by the SMF. QoS rules may be sent to the WTRU in a PDU session establishment accept message or a PDU session modification command message.

A QoS flow may be identified with a QoS flow ID (QFI). The QFI (e.g., in the downlink) may be carried from the UPF to the RAN in an encapsulation header (e.g., on N3 and/or N9). The (R)AN may map PDUs from QoS flows to access-specific resources based on the QFI and an associated QoS profile (e.g., an associated 5G QoS profile). The QoS profile that is associated with a QFI may be configured in the RAN by the SMF.

In the downlink, the SMF may configure the UPF to detect what QoS flow a downlink packet maps to, and the SMF may configure the RAN with information about the forwarding treatment for a QoS flow.

In the uplink, the SDAP layer may use the QoS rules and the QFI of the QoS flow to determine a DRB for the packet. The packet and selected DRB may be sent from the SDAP layer to the lower layers.

The lower layers may use the DRM to map the PDU to access-specific resources. The QoS profile that is associated with a QFI may be configured in the RAN by the SMF.

In the uplink, the SMF may configure the WTRU to detect what QoS flow an uplink packet maps to, and the SMF may configure the WTRU with information about the forwarding treatment for a QoS flow.

Different types of media may map to the same QoS flow. In examples, if two types of media (e.g., video and haptic feedback) have similar delay budget characteristics (e.g., requirements), both types of media may map to the same QoS flow. A single QoS flow may carry multiple types of media flows or data flows.

A QoS flow may be associated with a priority level. In the downlink, the SMF may configure a network node (e.g., a RAN/RAN node) with information about the forwarding treatment for a QoS flow. A QoS flow may be associated with a 5 QI value. A 5 QI value may be translated into the following characteristics used in the DL to determine the packet forwarding treatment: A resource type (e.g., non-GBR, GBR, delay-critical GBR); a priority level; a packet delay budget (e.g., including core network packet delay budget); a packet error rate; an averaging window (e.g., for GBR and delay-critical GBR resource type); and a maximum data burst volume (e.g., for delay-critical GBR resource type).

For a QFI, the QoS profile may indicate a 5 QI value and a priority level that is associated with the QFI. When a priority level is included in the QoS Profile, the priority in the QoS Profile may override the priority level that is associated with the 5 QI. The priority level in the QoS Profile may override the priority level that is associated with the 5 QI in the mapping table.

The priority level associated with 5G QoS characteristics may indicate a priority in scheduling resources among QoS flows.

The SMF may provide packet detection rules (PDR) to the UPF. The PDRs may be associated with QoS enforcement rules (QER). When the UPF detects that a packet matches the PDR, the QER may be applied.

A PDR may include an IP packet filter set, and if traffic matches the IP filter, QER may be applied. The PDR may include an application ID. The application ID may be an index to a set of application detection rules configured in the UPF. The application detection rule may be more granular than a simple IP filter.

Packet flow descriptions (PFDs) may be sent to the SMF, and the SMF may provide the PFDs to the UPF. A PFD may contain application detection rules. As mentioned herein, the rules may be more granular than an IP filter (e.g., a simple IP filter). In examples, a descriptor may include a simple IP Filter or URLs that may be matched (or domain names, or protocols). The PFD may have an application ID.

When the SMF gets a PFD, the SMF may look at the application ID of the PFD and check what PDRs have the same application ID. The SMF may check what UPFs have the PDRs with the matching application ID. The SMF may send the PFD to the UPFs (e.g., all of the UPFs that the SMF identified).

The SMF may send QoS rules to the WTRU and sends QER to the UPF. There may be no PFD -like functionality in the WTRU. The network may tell the WTRU to apply a certain QFI value to a certain IP flow, and the network may not tell the WTRU to apply a certain QFI value when it detects a particular URL name.

Packet importance may be derived from application layer headers. application layer Messages may be carried via protocols that indicate the type of payload carried in the message. In examples, an RTP message may carry (e.g., different) types of payloads. The format of the RTP header may vary depending on the payload type. For (e.g., some) payload types, the header may include an indication of the type of packet. In examples, when the RTP payload carries H.265 data, the RTP header may include a NAL unit type indication that indicates if the payload is a single NAL unit packet, part of an aggregation of packets, fragmentation units, or PACI packet. The NAL unit type indication may be used to indicate the importance of the payload.

A (e.g., different) type of application layer protocol is MOQ. In MOQ, the application may set an importance value or preferred delivery order with no absolute meaning. The importance value may indicate importance relative to the importance of the surrounding application layer messages.

The SDAP layer of the WTRU may map QoS flows to DRBs. One or more QoS flows may be mapped onto one DRB. One QoS flow may be mapped onto one DRB at a time in the UL.

In the downlink, the UPF may be configured with rules that the UPF can use to detect the format of the media that is carried in a PDU set. When the format of a PDU set is detected, the UPF may use information that is included in the header of the PDU to determine what PDU set importance to assign to the PDU set. In examples, if the UPF detects that the format of the PDU set is H.266 RTP, the UPF may use the NAL unit type field of the header to determine a PDU set importance value. If the PDU set importance value is a 4-bit value, then an example of a straightforward mapping from the NAL unit type field value to a PDU set importance value may be as follows.

The UPF may assign a PDU set importance value of 1 for (e.g., all) NAL unit type values from 0-25. The UPF may assign a PDU set importance value of 3 for (e.g., all) NAL unit type values of 28. The UPF may assign a PDU set importance value of 2 for (e.g., all) NAL unit type values of 29. The UPF may assign a PDU set importance value of 0 for (e.g., all) NAL unit type values of 26-27 and 30-31.

In examples described herein, that the media format types that are carried in a QoS flow may vary may not be considered. In examples, a QoS flow may carry both H.266 RTP payloads and haptic feedback. Using separate PDU set importance determination rules for a type of media may result in assigning PDU set importance values that that do not accurately reflect the relative importance of a (e.g., each) PDU set. The RAN may be influenced to drop packets that are relatively more important than other packets that are available to be dropped in other QoS flows.

It may not be practical for application developers to set an application-layer importance and an importance value that is specific to the network (e.g., the 5G network). The network may determine the importance of a packet based on information that is derived (or detected) in the application layer message (e.g., header or payload).

Example methods may be associated with enabling configuration of the UPF, so that the UPF can detect and indicate the relative importance of PDU sets, e.g., when the QoS flows carry varying types of media.

As described herein, when the RAN node receives PDU sets from UPF(s), the RAN node may use the PDU set importance values to make decisions about what PDU sets may (e.g., should) be dropped during a congestion situation. The PDU set importance value may indicate the relative importance of the PDUs that are carried in the QoS flow, and the RAN node may be configured with information to help determine the importance of a PDU set relative to the PDU sets of (e.g., other) QoS flows. As described above, the priority level of an individual QoS flow indicates the relative importance of a QoS flow relative to other QoS flows. An example of determining what PDU set(s) to drop during a congestion situation may be as follows: available (e.g., any available) PDU sets may be dropped with the lowest importance value in the lowest priority QoS flow. Available (e.g., any available) PDU sets may be dropped with the next highest importance value in the lowest priority QoS flow. The RAN may continue in this manner (e.g., drop PDU sets with the next highest importance value in the lowest priority QoS flow) until (e.g., all) the PDU sets of the lowest priority QoS flow are dropped. The (e.g., all of the) PDU sets of the lowest priority QoS flow may be dropped, and the RAN may begin dropping PDU sets from the next highest priority QoS flow.

In an example described herein, the RAN may drop (e.g., all) the PDU sets from low priority QoS flows while dropping no PDU sets from high priority QoS flows. The fact that the (e.g., all) PDU sets were dropped from the low priority QoS flow may be perceptible to a user. Meanwhile, there may have been PDU sets of relatively low importance that were available to be dropped in a high priority QoS flow. If the PDU set dropping would have been spread out across more QoS flow, the packet dropping may have been less perceptible to the user.

Example methods may be associated with enabling configuration of the RAN so that the RAN can more evenly spread out PDU set dropping events across QoS flows. Such a configuration may not instruct the RANIn examples, the RAN may not be instructed to make dropping decisions that are spread out evenly across QoS flows and may guide the RAN into making (e.g., more) balanced decisions that are not (e.g., that are less) perceptible to the user.

In the uplink, the WTRU may be configured with rules that the WTRU can use to detect the format of the media that is carried in a PDU set. When the format of a PDU set is detected, the WTRU may use information that is included in the header of the PDU to determine what PDU set importance to assign to the PDU set. In examples, if the WTRU detects that the format of the payload/PDU set is H.264 RTP, the WTRU may use the unit type field of the header to determine a PDU set importance value. If the PDU set importance value is a 4-bit value, a mapping example described herein as taking place in the UPF may take place in the WTRU. The example may result in drawbacks that are described herein. The example may not account (e.g., account well) for the fact that the media format types that are carried in a QoS flow may vary.

Example methods may be associated with enabling configuration of the WTRU, such as the WTRU upper layers (e.g., WTRU SDAP layer), so that the WTRU upper layers can detect and indicate the relative importance of PDU sets when the QoS flows carry varying types of media. The WTRU upper layers may provide relative importance information to the lower layers (e.g., lower layers of the WTRU) so that the lower layer can efficiently (e.g., more efficiently) prioritize PDU sets across QoS flows and within QoS flows. Efficient prioritizing of PDU sets may include lower layers using information that is provided by the SDAP layer to determine how much of a QoS flow with a relatively low priority level may be deprioritized before it is preferable, from a QoE perspective, to deprioritize PDUs from a QoS flow with a relatively higher priority level.

Features described herein may be associated with how a (e.g., 5G) system can be modified in terms of how downlink traffic is handled. The enhancements may describe how the UPF can determine the importance of a PDU set relative to PDU sets that were previously sent in the same QoS flow and provide the importance information to the RAN node. The RAN node may be configured with information so that the RAN can prioritize packets based on the PDU set importance value and the priority level of the QoS flow and based on how much traffic may be discarded from a QoS flow before the user detects a degradation in QoE. The RAN node may select packets for discarding in a way that is less likely to impact the overall user QoE.

Features described herein may be associated with how a (e.g., 5G) system can be modified in terms of how uplink traffic is handled. The enhancements may describe how the WTRU upper layers can determine the importance of a PDU set relative to PDU sets that were previously sent in the same QoS flow and provide the importance information to the WTRU lower layers. The WTRU lower layers may prioritize packets based on the PDU set importance value and the priority level of the QoS flow and based on how much traffic can be discarded from a QoS flow before the user detects a degradation in QoE. The WTRU may prioritize packets in a way that is not likely (e.g., less likely) to impact the overall user QoE.

Features described herein may be associated with downlink handling of PDU set importance. In the downlink, data may be sent from an application server to a WTRU. Data from the application server may enter the (e.g., 5GP) Core network via a UPF. The UPF may use a PDU session of the WTRU to deliver the data to the WTRU via a RAN node. The SMF may configure the UPF and RAN node with information that is used by the UPF and RAN node to determine how to treat (e.g., prioritize) traffic of the PDU session. The following may describe how the SMF, UPF, and RAN node can determine the importance of PDUs, assign an importance value to a PDU, and use the PDU set importance value to prioritize PDUs, such that the user of the WTRU is less likely to notice a degradation in QoE when PDUs are (e.g., need to be) discarded by the network (e.g., RAN node) during periods of congestion. The SMF may configure the UPF and RAN nodes based on PCC rules that were received from the PCF. The PCF may derive the PCC rules based on information that was received from the AF/AS.

In examples (e.g., downlink), relative importance may be identified and relative importance may be conveyed to the RAN node. A UPF may be configured with PDU set importance Assignment rules that the UPF can use to determine the importance of a PDU set relative to the PDU sets that were recently sent from the UPF to the RAN node.

A network node (e.g., a user plane function (UPF)) may receive a rule, such as a packet data unit (PDU) set importance (PDSI) assignment rule, for example, the PDSI rule may be received in a first message (e.g., an N4 message). The PDSI rule may be received from an SMF. As described herein, a PDU set assignment rule and a PDSI assignment rule may be used interchangeably (e.g., the PDU set assignment rule may include the PDSI assignment rule). As described herein, a PDU set base value and a PDSI base value may be used interchangeably (e.g., the PDU set base value may include the PDSI base value). As described herein, a previous PDU set value and a previous PDSI value may be used interchangeably (e.g., the previous PDU set value may include the previous PDSI value).

The PDSI assignment rule may be associated with a QoS flow. The UPF may receive a downlink data packet (e.g., a PDU). The UPF may send (e.g., in a second message) the downlink data packet and the PDU set importance value of the downlink data packet (e.g., to a RAN node, for example in a GTP-U message).

A protocol data unit (PDU) set importance (PDSI) assignment rule may include information indicative of an assignment rule for PDU set importance (e.g., a priority of a PDU set). PDU set importance and PDSI may be used interchangeably as described herein. PDSI assignment rule, logical rule, priority rule, importance rule, and logical priority rule may be used interchangeably herein. In examples, the PDSI assignment rule may include a logical rule that may determine an importance for a PDU set. In examples, the PDSI assignment rule may include data and/or code that when processed by a processor may determine an importance. In examples, the PDSI assignment rule may include information corresponding to one or more of the following: a protocol discriminator, a security header, an authorization code, a sequence number, a message type, and/or a payload container. The PDSI assignment rule may affect a priority of the PDU with respect to a layer (e.g., a particular layer) of a WTRU. A PDSI assignment rule may include information indicative of a logical rule that may determine the importance (e.g., an objective importance, a relative importance, etc.) of data (e.g., a PDU, PDU set, a QoS flow, or the like). The data may have a priority (e.g., a particular priority) in a layer (e.g., a particular layer). The PDSI assignment rule may correlate to a priority associated with a layer (e.g., high/medium/low).

Relative importance may be identified by the UPF.

The SMF may configure the UPF with rules that are used by the UPF to determine what PDU set importance value are to be indicated to the RAN when the UPF sends a PDU set to the RAN. The indication may be sent from the UPF to the RAN in the header of the GTP-U message(s) that are used to send the PDU set to the RAN. The SMF may configure the UPF by sending a (e.g., N4) message to the UPF during a PDU session establishment or PDU session modification procedure.

The UPF may be configured with packet detection rules (PDRs) that are used by UPF to detect the format of the packet and assign a packet to a QoS flow. Detecting the format of the packet may mean that the UPF detects the type of media that is carried in the packet. In examples, the UPF may receive a PDR that includes an application ID that identifies an application detection rule. The application detection rule may be a rule that is used by the UPF to detect a certain media format. The PDR may be associated with a PDSI assignment rule. The PDSI assignment rule may be part of a QoS enforcement rule (QER). The PDSI assignment rule may be a rule that is used by the UPF to determine what PDU set importance value to assign to a PDU set.

A PDSI assignment rule may be associated with an application identifier (e.g., an application type). The application identifier may identify a protocol and media type combination (e.g. RTP H.265). The application identifier and/or the PDSI assignment rule may identify a relative importance determination (RID) rule. The RID rule may list the possible values of one or more header fields that are associated with the protocol and media type combination. The list may be presented in increasing or decreasing order to indicate to the UPF how to use the one or more header fields to determine the importance of the packet relative to other packets. For a header field that is associated with the protocol and media type combination, the list may indicate how much greater or less the assigned PDU set importance value is/should be relative to the PDU set importance of the previous PDU set. Different RID rules may be used concurrently, e.g., for different applications or flows.

A (e.g., each) PDSI assignment rule may include a PDSI base value. The base value may indicate a starting value for PDU set importance. In examples, the PDSI base value may be assigned to the first PDU set that the UPF receives that matches the protocol and media type combination that is identified by the application identifier. The UPF may assign a higher PDU set importance value to the next PDU set (e.g., a second PDU set) if the next PDU is more important than the first PDU set. The UPF may assign a lower PDU set importance value to the next PDU set if the next PDU is less important than the first PDU set. The UPF may assign the same PDU set importance value to the next PDU set if the next PDU is the same importance as the first PDU set. As described herein, the RID rule may be used to determine the importance of the next PDU set relative to the first PDU set.

When assigning a PDSI base value to a QoS flow/protocol/media type combination, the system (e.g., SMF) may configure the UPF(s) such that different QoS flows use different PDSI base values. Using different base values may allow the system to configure relatively higher base values for QoS flows or protocol/media format combinations that are relatively more important than other QoS flows or protocol/media format combinations.

A PDSI assignment rule may describe a PDSI reset trigger. The PDSI assignment rule may indicate to the UPF what event may (e.g., should) trigger the UPF to assign the PDSI base value to a PDU set.

In examples, the PDSI assignment rule may indicate a time value to the UPF. The time value may be the PDSI reset trigger, and the time value may indicate to the UPF that, if no PDU sets are received for the QoS flow within the time value, the UPF may (e.g., should) assign a PDSI value to the next PDU set has an equal PDSI base value. Enough time may have passed that it is unlikely that the RAN node is (e.g., still) buffering PDU sets for the QoS flow. There may be no value in indicating the PDU set importance relative to a PDU set that the RAN node has already transmitted.

In examples, the PDSI assignment rule may indicate an application ID (e.g., an application type) to the UPF. The application ID may be the PDSI reset trigger (e.g., the detection of the application ID may be used to determine that the PDSI assignment rule is to be applied). The application ID may point to, or identify, an application detection rule. If the UPF detects traffic that matches the application detection rules, the UPF may assign a PDSI value to the next PDU set that has an equal PDSI base value. A PDSI value may be assigned to the next PDU set that has an equal PDSI base value because the packet that matches the application detection rule is not be correlated with the packet that was previously sent (e.g. because a significant amount of time has passed since the previous pack was sent). The packet that matches the application detection rule may have no importance relative to the packet that was last received.

In examples, the PDSI assignment rule may indicate a protocol/media type/field value to the UPF. The protocol/media type/field value may include the PDSI reset trigger. If the UPF detects traffic that matches the identified protocol type and media payload type, the UPF may check if the identified field matches the value that was provided in the PDSI reset trigger. If there is a match, the UPF may assign a PDSI value to the next PDU set that has an equal PDSI base value. The packet that matches the combination may be representative of a packet that is not associated with (e.g., typically associated with), or correlated with, the packet that was previously sent. The packet that matches the combination may have no importance relative to the packet that was last received.

When the UPF determines to assign a PDU set importance value based on the reset trigger (e.g., decides to assign the PDSI base value), the UPF may indicate to the RAN node that the PDU set is being assigned the PDSI base value (e.g., because the UPF has determined that the PDU set is not associated with the previous PDU set (e.g., it is part of a new burst of data)). The indication may be sent to the RAN node in the GTP-U header with the PDU set importance value. If the UPF determines to assign the PDSI base value, the UPF may indicate (e.g., may also indicate) to the RAN node that the PDU set be considered lower in priority than the PDU set that was previously sent, higher in priority than the PDU set that was previously sent, or the same priority as the PDU set that was previously sent. The indication may be sent to the RAN node in the GTP-U header with the PDU set importance value.

In examples involving a RAN node, PDU importance may be used to determine what packets to drop during congestion.

When the RAN receives a PDU of a PDU set from the UPF, the PDU may be received in a GTP-U packet. The header of the GTP-U packet may indicate the PDU set importance value of the PDU set. The PDU set importance value may have been assigned by the UPF as described herein. In a congestion situation, the RAN may use the PDU set importance value to determine what PDU(s) to drop or discard in order to resolve congestion. Since the same PDU set importance value may be assigned to the (e.g., all) PDUs of a PDU set, the UPF may choose to include no PDU set importance in the GTP-U. The fact that there is not a PDU set importance value in the header may indicate that the PDU set importance value was indicated in the message that carried an earlier PDU of the same PDU set.

As described herein, the PDU set importance value may indicate to the RAN node the relative importance of a PDU relative to other PDU(s) of the same QoS flow. When the RAN determines what PDU(s) to drop, or discard in a congestion situation the RAN may select PDU(s) to drop from a (e.g., any) QoS flow. Priority level may be a parameter that is assigned to a (e.g., an entire) QoS flow and may indicate to the RAN the relative priority of a QoS flow to other QoS flow. As described herein, the parameter may indicate the importance of the QoS flow relative to other QoS flows and may not (e.g., in no way) account for the fact that the PDUs within a QoS flow may vary in importance.

As described herein, a discarding or dropping example where the RAN drops packets from the lowest priority flows may lead to a QoE decrease that is noticeable to the user.

During a PDU session establishment or PDU session modification procedure, the SMF may send the RAN node a discard factor for a QoS flow. The discard factor may be sent to the RAN node by the SMF via the AMF. The AMF may forward the message to the RAN node in an (e.g., N2) message. The discard factor of a (e.g., each) QoS flow may be included as part of the QoS profile of the PDU session. The discard factor may indicate to the RAN node what percentage of PDUs can be dropped from a QoS flow before it can be expected that the user notices a degradation in QoE. The RAN node may use the value to determine when to stop discarding packets from a first QoS flow and begin discarding packets from a second QoS flow which has been assigned a higher overall priority level.

In a downlink example associated with a RAN node, relative importance and a discard factor may be used to determine packet drop eligibility.

A WTRU may be configured with PDU set importance assignment rules and a discard factor. The WTRU upper layers may use the PDU set importance assignment rules to determine the importance of a PDU set relative to PDU sets that were (e.g., recently) sent from the WTRU upper layers to the WTRU lower layers. The WTRU Upper layers may determine a discard factor, and the WTRU lower layers may use the PDU set importance value and discard factor to determine what logical channel to assign the PDU set to.

Discard factors (e.g., multiple discard factors) may be provided to the RAN node for a (e.g., each) QoS flow. There may be one discard factor associated with a (e.g., each) PDU set importance value or a (e.g., each) range of PDU set importance values. The RAN node may be configured, so that the RAN node will drop a relatively high percentage of low importance PDUs in a QoS flow and relatively low percentage of high importance PDUs in a QoS flow.

The discard factor may be important to convey to the RAN node because, without it, the RAN would be limited to using the priority level of the QoS flow when making discard decisions, and, as described herein, an example that relies on a priority level may result in a large percentage (e.g., too large of a percentage) of dropped packets from a (e.g., a single) QoS flow and cause a degradation in the QoE of the user. Examples described herein may enable a RAN configuration that will avoid discarding a large percentage (e.g., too large of a percentage) of dropped packets from a single QoS flow.

In order to spread dropping out more evenly over time, the discard factor may be presented as a percentage per unit of time.

The discard factor may be explicitly signaled to the PCF by the AF when the AF configured a QoS for a session. The AF may indicate the type of data in a flow, and the PCF may use the indication to determine the discard factor. The PCF may provide the discard factor to the SMF as part of the PCC rules.

An example of how the discard factor may be applied is as follows. During a period of congestion, the RAN may begin a process where PDUs are discarded. The RAN may begin dropping packets from the lowest priority QoS flow. When (e.g., each time) the RAN drops a packet from the QoS flow, the RAN may calculate the percentage of packets that were dropped from the QoS flow over a time period. The RAN may compare the calculated percentage against the discard factor of the QoS flow. If the percentage is lower than the discard factor, the RAN may continue to drop packets from the QoS flow until the congestion is resolved or until the calculated percentage is greater than or equal to the discard factor. When the result of the calculation is greater than or equal to the discard factor, the RAN may begin discarding packets from the QoS flow that is next highest in priority. The RAN may continue dropping PDUs from the QoS flow that is next highest in priority until the percentage of drop packets exceeds or is equal to the discard factor of the QoS flow that is next highest in priority. Once the percentage of drop packets exceeds or is equal to the discard factor of the QoS flow that is next highest in priority, the RAN will decide to begin dropping packets from a third QoS flow. The RAN may select the QoS flow that is next highest in priority, or the RAN may again choose the QoS flow that is lowest in priority (e.g., if enough time has passed to make the percentage of dropped packets from the first QoS flow lower than the discard factor of the first QoS flow).

Features described herein may be associated with an uplink handling of PDU set importance.

In the uplink, data may be sent from a WTRU application to an application server. The WTRU may use a PDU session to send the data to a UPF via a RAN node. The SMF may configure the WTRU, UPF, and RAN node with information that is used by the WTRU and RAN node to determine how to treat (e.g., prioritize) traffic of the PDU session. The following examples may describe how the SMF, WTRU, and RAN node can determine the importance of PDUs, assign an importance value to a PDU, and use the importance value to prioritize PDUs such that the user of the WTRU is less likely to notice a degradation in QoE when PDUs are prioritized and assigned to network resources (e.g. logical channels) by the WTRU.

The SMF may configure the WTRU with rules that are used by the WTRU to determine what PDU set importance value may (e.g., should) be indicated by the SDAP layer to the lower layers when the SDAP layer sends a PDU to the lower layers. The SMF may configure the WTRU by sending a NAS message to the WTRU during a PDU session establishment or PDU session modification procedure. In examples, the configuration information may be sent an PDU session establishment accept message or a PDU session modification command message.

The QoS rules that are sent to the WTRU may be modified to include application ID(s) that identify an application detection rule. The application detection rule may be a rule that is used by the WTRU to detect a certain media format. When the WTRU upper layer determines that a packet of application traffic matches the application detection rule, the WTRU may assign the packet to a QoS flow. The QoS rule may be associated with a PDSI assignment rule. The PDSI assignment rule may be part of a QoS rule. Similar to examples described herein (e.g., for the UPF), the PDSI assignment rule may be a rule that is used by the WTRU to determine what PDU set importance value to assign to a PDU set. As described herein, the PDSI assignment rules may include application identifier(s), PDSI base value(s), and PDSI reset triggers. The application identifier may further identify a relative importance determination (RID) rule. The QoS rule may be associated with a WTRU discard factor. The WTRU discard factor may be part of a QoS rule. Similar to an example described herein (e.g., for the RAN node), the WTRU discard factor may indicate to the WTRU what percentage of PDUs can be dropped from a QoS flow before it can be expected that the user will notice a degradation in QoE. The PDSI assignment rule may describe how to detect the traffic that the rule applies to (e.g. use the application detection rule that is identified by the application identifier), indicate how to inspect the traffic deeply (e.g. look at the header), and determine the PDU set importance value (e.g. use a header value and the PDU set importance value that was assigned to the previous packet).

The discard factor that is configured in the RAN and is described above may be called a RAN discard factor or a downlink discard factor. As described above, the RAN discard factors are configured in the RAN by the SMF in the QoS profile.

The discard factor that is configured in the WTRU and is described herein may be called a WTRU discard factor or an Uplink discard factor. As described herein, the WTRU discard factors may be configured in the WTRU by the SMF in the QoS rules.

The SMF may determine the WTRU discard factors and the RAN Discards Factors based on PCC rules or an explicit indication from the PCF. The information from the PCF may be based on information from the AF (e.g. discard factors or traffic type information from the AF).

The SMF may choose to send different discard factors to the WTRU and RAN for QoS flows that are associated with the same IP 4-tuples. In examples, downlink traffic may be more important than uplink traffic.

The application detection rule that is identified by the application ID may be configured in the WTRU. The information may be configured in the WTRU in a NAS message. In an example, the information may be configured in the WTRU, and the PCF may send the WTRU a list of application ID(s) and a URL that is associated with an (e.g., each) application ID. The URL may be used by an application layer of the WTRU to contact a server and download the application detection rule from the server. The WTRU application may subscribe to the server to receive updated versions of the application detection rule from the server. The list of application ID(s) and associated URL(s) may be called a WTRU application ID mapping table.

The WTRU application ID mapping table may include the application detection rule instead of the URL that is used to download the application detection rule. When including the application detection rule instead of the URL, the WTRU may not use (e.g., may not need to use) a WTRU application to download the application detection rule over the user plane. When including the URL in the WTRU application ID mapping table, application detection rules (which may be relatively large) may not be (e.g., may not need to be) sent in a message (e.g., a NAS) message and may be downloaded and updated (e.g., on an as-needed basis).

An application layer may provide an application layer packet to the WTRU upper layers, and the WTRU upper layers may use the QoS rules to assign the packet to a QoS flow and may use the PDSI assignment rule to determine a PDU set importance value for a (e.g., each) PDU. The PDU set importance value may be assigned as described herein. If the WTRU upper layer detects traffic that matches the identified protocol type and media payload type, the WTRU upper layer may check if the identified field matches the value that was provided in the PDSI reset trigger. If there is a match, then the UPF may assign a PDSI value to the next PDU set that is an equal PDSI base value. The packet that matches the combination may be representative of a packet that is not associated with (e.g., not typically associated with), or correlated with, the packet that was previously sent. The packet that matches the combination may have no importance relative to the packet that was last received. The WTRU Upper layer may assign the PDSI base value to the first PDU set that the WTRU upper layer receives from an application that matches the protocol and media type combination that is identified by the application identifier. The WTRU upper layer may assign a higher PDU set importance value to the next PDU set if the next PDU is more important than the first PDU set. The WTRU upper layer may assign a lower PDU set importance value to the next PDU set if the next PDU set is less important than the first PDU set. The WTRU upper layer may assign the same PDU set importance value to the next PDU set if the next PDU is the same importance as the first PDU set. As described herein, the RID rule may be used by the WTRU upper layer to determine the importance of the next PDU set relative to the first PDU set.

The SDAP layer may send to the PDU the determined PDU set importance value and the discard factor to the WTRU lower layers. The WTRU lower layers may use the PDU set importance value and discard factor to determine what logical channel to assign the PDU set to (e.g., instead of assigning (e.g., all) the PDUs from one DRB to the same logical channel). In examples, the packets that are important (e.g., more important) may be assigned to logical channels that are configured to be important (e.g., more important) and may be prioritized in terms of allocating network resources. In examples, packets that are associated with a larger discard factor may be allocated to a logical channel that is allocated relatively less network resources.

When the SDAP layers sends the lower layer a PDU set importance value that is based on the reset trigger (e.g., the upper layers decide to assign the PDSI base value), the SDAP layer may indicate to the lower layers that the PDU set is being assigned the PDSI base value because the WTRU upper layers have determined that the PDU set is not associated with the previous PDU set (e.g., the PDU set is part of a new burst of data). The indication may be sent to the lower layers with the PDU set importance value. As described herein, data sent to a particular layer (e.g., a higher layer/a lower layer) may be indicative of sending data to a device irrespective of a layer (e.g., sending data to a network node, a WTRU, a base station, a network, etc.).

A WTRU, UPF, and RAN node of a PDU session may be configured (e.g., by an SMF) to deal with relative importance (e.g., for uplink and downlink).

In order to configure a PDU session, an SMF may send a first PDSI assignment rule to a WTRU in a NAS message. The PDSI assignment rule may be associated with a QoS flow. The PDSI assignment rule may include a PDSI base value and a discard factor. The SMF may send a second PDSI assignment rule to a UPF in a message (e.g., an N4 message). The PDSI assignment rule may be associated with a QoS flow and may include a PDSI base value. The SMF may send a discard factor to a RAN node in a message (e.g., an N2 message). The discard factor may be associated with a QoS flow and may be sent in a QoS profile.

A network node (e.g., an SMF) may detect a triggering event. The SMF may send a first PDSI assignment rule to a WTRU in a message (e.g., a NAS message). The PDSI assignment rule may be associated with a QoS flow. The PDSI assignment rule may include a PDSI base value and a discard factor. An SMF may send a second PDSI assignment rule to a network node (e.g., a UPF) in a message (e.g., an N4 message). The PDSI assignment rule may be associated with a QoS flow and may include a PDSI base value. An SMF may send a discard factor to a RAN node in a message (e.g., an N2 message). The discard factor may be associated with a QoS flow and may be sent in a QoS profile.

One or more of the first PDSI assignment rules or the second PDSI assignment rules may include a PDSI reset trigger. The PDSI reset trigger may indicate a condition that may trigger the WTRU or UPF to assign the PDSI base value as the PDU set importance value of a data packet. In examples, the PDU set importance reset trigger may indicate a condition, and the SMF may, based on the condition being satisfied, assign the first PDU set importance base value as the PDU set value of a downlink PDU. In examples, based on the condition being satisfied, the SMF may assign the second PDU set importance base value as the PDU set importance value of a downlink PDU.

The reset trigger may indicate a time value, an application ID, or a protocol/media type/field value combination, and when the combination is detected in the downlink packet, the WTRU or UPF may be triggered to assign the PDSI base value as the PDU set importance value of the data packet.

The reset trigger may indicate a time value, and when the duration between receiving or sending PDU sets for the same QoS flow exceeds the time value, the WTRU or UPF may be triggered to assign the PDSI base value as the PDU set importance value of the next data packet.

The reset trigger may indicate an application ID, and when the WTRU detects that the uplink packet matches the application detection rule that is identified by the application ID, the WTRU or UPF may be triggered to assign the PDSI base value as the PDU set importance value of the data packet.

The reset trigger may indicate a protocol/media type/field value combination, and when the WTRU or UPF detects that the uplink packet matches the combination, the WTRU or UPF may be triggered to assign the PDSI base value as the PDU set importance value of the data packet.

The NAS message may be a PDU session establishment accept message or a PDU session modification message.

The first PDSI assignment rule may be part of a QoS rule.

The NAS message may include a mapping table that indicates that at least one URL is associated with at least one application ID.

The triggering event may be reception of a PDU session establishment request from the WTRU, reception of a PDU session modification request from the WTRU, or reception of updated PCC rules from a PCF.

PDU set importance may be handled in a PDU session.

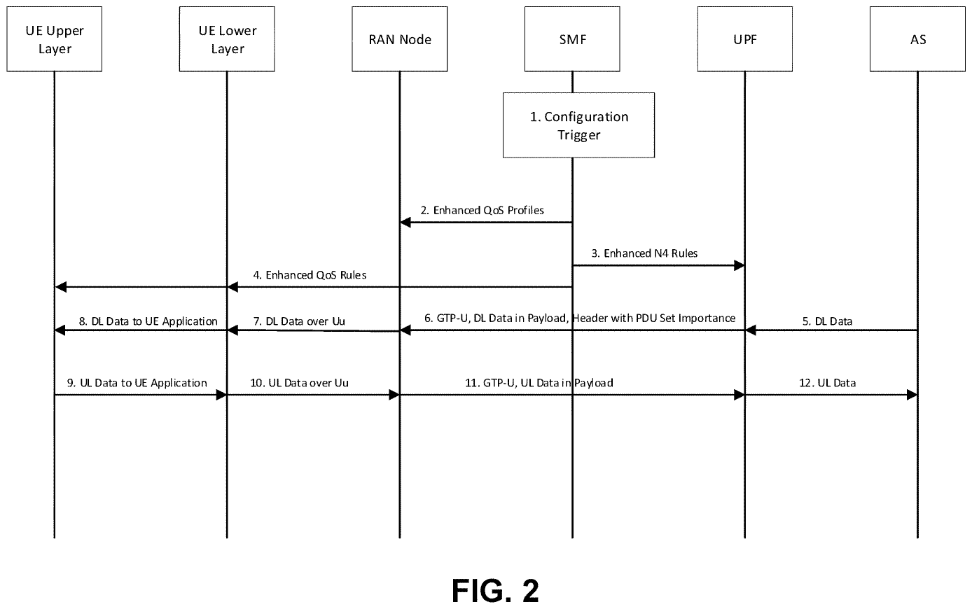

The example of FIG. 2 may illustrate an example of how feature(s) described herein may be executed. FIG. 2 illustrates an example handling of PDU set importance in a PDU session, where one or more of the following may be performed.

At 1, a network node (e.g., the SMF) may detect a triggering event. The triggering event may be reception of a PDU session establishment request from the WTRU, reception of a PDU session modification request from the WTRU, or a reception of updated PCC rules from a PCF.

At 2, based on the triggering event and as described above, the SMF may send QoS profiles to the RAN node. The QoS profiles may include a discard factor for a (e.g., each) QoS flow.

At 3, based on the triggering event and as described above, the SMF may configure the UPF with rules (e.g., a PDSI assignment rule and one or more of a PDSI base value or a previous PDSI value corresponding to a previous PDU) that are used by the UPF to determine what PDU set importance value may (e.g., should) be indicated to the RAN when the UPF sends a PDU set to the RAN. The configuration information may be sent to the UPF in a message (e.g., N4 message). The configuration information may be the PDSI assignment rule that is described herein, and the configuration information may be used to detect traffic that the rule applies to. The configuration information may be used to determine a PDU set importance value to assign to the PDU.

At 4, based on the triggering event and as described above, the SMF may configure the WTRU with rules that are used by the WTRU to determine what PDU set importance value may (e.g., should) be indicated by the SDAP layer to the lower layers (e.g., WTRU lower layers) when the SDAP layer sends a PDU to the lower layers. The configuration information may be sent to the WTRU in a message (e.g., a NAS message). If the triggering event at 1 was a PDU session establishment request, the SMF may send the configuration information to the WTRU in a message (e.g., a PDU session establishment accept message). If the triggering event at 1 was a was PDU session modification request or the reception of PCC rules (e.g., updated PCC rules) from the PCF, the SMF may send the configuration information to the WTRU in a message (e.g., a PDU session modification message).

At 5, the application server may send downlink traffic to the WTRU (e.g., via the internet). The downlink traffic may enter the system via the UPF on the (e.g., N6) interface.

At 6, as described above, the UPF may use the rules (e.g., the PDSI assignment rule and one or more of a PDSI base value or a previous PDSI value corresponding to a previous PDU) that were received at 3 to determine a PDU set importance value for a downlink packet (e.g., a PDU), and the PDU set importance value may be sent from the UPF to the RAN in the header of message(s) (e.g., the GTP-U message(s)) that are to send the packet to the RAN node.

At 7, as described herein, the RAN node may receive the packet and the PDU set importance value and may use the PDU set importance value and information from the QoS profile that was received at 2 to determine what PDU(s) to drop or discard to resolve congestion. The packets that are not discarded by the RAN may be transmitted to the WTRU. The PDU set importance value and information from the QoS profile that was received at 2 may be used to determine what logical channel to assign the packet to.

At 8, the packets (e.g., including PDU(s) that are received by the WTRU may be passed to (e.g., sent to) the WTRU upper layers (e.g., to the SDAP layer and to the WTRU application).

At 9, the WTRU application may attempt to send a packet, and the WTRU may use the QoS rules (e.g., the modified QoS rules) that were received at 4 to assign a PDU set importance value for the packet, assign the packet to a QoS flow, and determine a discard factor for the QoS flow. The packet, PDU set importance value, and discard factor may be sent to the WTRU layer (e.g., the WTRU lower layer).

At 10, the WTRU lower layers may use the PDU set importance value and discard factor to determine how to prioritize the uplink packet (e.g., what logical channel to assign the PDU set to). In examples, as described herein, the WTRU may (e.g., the WTRU lower layers) may use the PDU set importance value and discard factor to determine what logical channel to assign the PDU set to (e.g., instead of assigning all the PDUs from one DRB to the same logical channel).

At 11, the UL data may be received by the RAN node. The RAN node may determine what PDU session the data is associated with and use the GTP-U tunnel that is associated with the PDU session to send the UL data to the UPF.

At 12, the UPF may receive the packet from the GTP-U message and send the PDU (e.g., IP Packet) to the AS on the (e.g., N6) interface.

Systems, methods, and instrumentalities are disclosed for a user plane function (UPF) determining relative protocol data unit (PDU) set importance within a quality of service (QoS) flow. The first network node (e.g., the UPF) may be configured to receive, from a second network node, a first message indicating a protocol data unit (PDU) set importance assignment rule associated with a quality of service (QoS) flow. The first network node may receive a first downlink PDU. The first network node may determine a PDU set importance value associated with the first downlink PDU based on the PDU set importance assignment rule and one or more of a PDU set base value or a previous PDU set importance value corresponding to a previous PDU. The first network node may send, to a third network node, a second message. The second message may include the first downlink PDU and an indication of the PDU set importance value.

The PDU set importance assignment rule may be associated with a PDU set importance reset trigger that indicates a condition. The first network node may assign the PDU set base value as the PDU set importance value based on the condition being satisfied.

The PDU set importance assignment rule may be associated with a PDU set importance reset trigger, and the PDU set importance reset trigger may indicate a time value. The first network node may assign the PDU set importance base value as the PDU set importance value for a second downlink PDU on a condition that a duration associated with sent or received PDU sets for the QoS flow exceeds the time value.

The first network node may determine that the PDU set importance assignment rule is to be applied for the first downlink PDU based on an application type. The first network node may include a user plane function (UPF), and the second network node may include a session management function (SMF), and the third network node may include a radio access network (RAN) node.

The PDU set importance assignment rule may include a PDU set importance (PDSI) assignment rule. The PDU set importance base value may include a PDSI base value, and the previous PDU set value may include a previous PDSI value. The PDU set importance base value may indicate a starting value of the PDU set importance value.

Systems, methods, and instrumentalities are disclosed for a wireless transmit/receive unit (WTRU) determining relative protocol data unit (PDU) set importance within a quality of service (QoS) flow. The WTRU may be configured to receive, in a first message from a network node, a protocol data unit (PDU) set importance assignment rule corresponding to a quality of service (QoS) flow. The WTRU may receive a PDU from an application associated with the WTRU. The WTRU may determine, based on the PDU set importance assignment rule and one or more of a PDU set importance base value or a previous PDU set importance value associated with a previous PDU, a PDU set importance value associated with the PDU. The WTRU may determine, based on the PDU set importance assignment rule, a discard factor for the PDU. The WTRU may send PDUs associated with the QoS flow in accordance with the PDU set importance value and the discard factor.

The first message may include a PDU session establishment accept message or a PDU session modification command message. The WTRU may determine a first logical channel for a first PDU of the PDUs based on the PDU set importance value and the discard factor. The WTRU may determine a second logical channel for a second PDU of the PDUs based on the PDU set importance value and the discard factor. The WTRU may send the first PDU on the first logical channel and the second PDU on the second logical channel.

The PDU set importance base value may indicate a starting value for the PDU set importance value. The PDU set importance assignment rule may include a PDU set importance (PDSI) assignment rule. The PDU set importance base value may include a PDSI base value. The PDU set importance base value may include a PDSI base value. The network node may include a session management function (SMF).

Systems, methods, and instrumentalities are disclosed for a radio access network (RAN) determining relative protocol data unit (PDU) set importance within a quality of service (QoS) flow. A first network node (e.g., the RAN) may be configured to receive, from a second network node, a first message. The first message may include a QoS profile, and the QoS profile may indicate a discard factor. The first network node may receive a protocol data unit (PDU) set importance value and a downlink PDU. The first network node may determine transmission information based on the discard factor and the PDU set importance value. The first network node may send a transmission in accordance with the determined transmission information.

The determined transmission information may indicate to drop at least one PDU from a plurality of PDUs. The transmission may not include the at least one PDU. The determined transmission information may indicate to assign the downlink PDU to a logical channel. The downlink PDU may be sent via the logical channel. The discard factor may include an indication indicating that downlink PDUs are not to be dropped from a QoS flow. The first message may include an indication indicating that the discard factor corresponds to the PDU set importance value or plurality of PDU set importance values. The discard factor may indicate a percentage of PDUs that can be dropped OR a percentage of PDUs to drop. The first network node may determine the percentage based on a degradation threshold associated with a QoS flow. The protocol data unit (PDU) set importance value may include a PDU set importance (PDSI) value. The second network node may include a session management function (SMF).

Systems, methods, and instrumentalities are disclosed for a session management function (SMF) determining relative protocol data unit (PDU) set importance within a quality of service (QoS) flow. A first network node (e.g., the SMF) may be configured to detect a triggering event. The first network node may send, to a first wireless transmit receive unit (WTRU), a first message. The first message may include a first protocol data unit (PDU) set importance assignment rule. The first PDU set importance assignment rule may correspond to a quality of service (QoS) flow. The first PDU set importance assignment rule may indicate a first PDU set importance base value and a discard factor.

The first network node may send, to a second network node, a second message. The second message may include a second PDU set importance assignment rule. The second PDU set importance assignment may be associated with the QoS flow. The second PDU set importance assignment rule may indicate a second PDU set importance base value.

The first network node may send, to a third network node, a third message. The third message may include a QoS profile. The QoS profile may indicate a discard factor. The discard factor may correspond to the QoS flow. The second PDU set importance assignment rule may include a PDU set importance reset trigger. The PDU set importance reset trigger may indicate a condition. The first network node may, based on the condition being satisfied, assign the first PDU set importance base value as the PDU set value of a downlink PDU.

The first PDU set importance assignment rule may include a PDU set importance reset trigger. The PDU set importance reset trigger may indicate a condition. The first network node may, based on the condition being satisfied, assign the second PDU set importance base value as the PDU set importance value of a downlink PDU. The triggering event may be associated with one or more of a PDU session establishment request, a PDU session modification request, or receiving PCC rules.

The second network node may include a user plane function (UPF), and the third network node may include a radio access network (RAN) node. The first message may include a non-access stratum (NAS) message. The NAS message may correspond to one or more of a PDU session establishment accept message or a PDU session modification command message. The first PDU set importance assignment rule may include a first PDU set importance (PDSI) assignment rule. The second PDU set importance assignment rule may include a second PDU set importance (PDSI) assignment rule. The first PDU set importance base value may include a first PDSI base value. The second PDU set importance base value may include a second PDSI base value.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read-only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer-executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices may include personal computers, network servers, handheld devices, supercomputers, or computers integrated into other systems such as automobiles and airplanes.

In describing the preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-14. (canceled)

15. A first network node, the first network node comprising:
a processor configured to:
detect a triggering event;
send, to a first wireless transmit receive unit (WTRU), a first message, wherein the first message comprises a first protocol data unit (PDU) set assignment rule corresponding to a quality of service (QoS) flow, and wherein the first PDU set assignment rule indicates a first PDU set base value and a discard factor;
send, to a second network node, a second message, wherein the second message comprises a second PDU set assignment rule associated with the QoS flow, and wherein the second PDU set assignment rule indicates a second PDU set base value; and
send, to a third network node, a third message, wherein the third message comprises a QoS profile, and wherein the QoS profile indicates the discard factor, and wherein the discard factor corresponds to the QoS flow.

16. The first network node of claim 15, wherein the second PDU set assignment rule comprises a PDU set reset trigger indicating a condition, and wherein the processor is further configured to:
based on the condition being satisfied, assign the second PDU set base value as the PDU set value of a downlink PDU.

17. The first network node of claim 15, wherein the first PDU set assignment rule comprises a PDU set reset trigger indicating a condition, and wherein the processor is further configured to:
based on the condition being satisfied, assign the first PDU set base value as the PDU set value of a downlink PDU.

18. The first network node of claim 15, wherein the triggering event is associated with one or more of a PDU session establishment request, a PDU session modification request, or receiving policy and charging control (PCC) rules.

19. The first network node of claim 15, wherein the first network node comprises a session management function (SMF).

20. The first network node of claim 15, wherein the first message comprises a non-access stratum (NAS) message, and wherein the NAS message corresponds to one or more of a PDU session establishment accept message or a PDU session modification command message.

21. The first network node of claim 15, wherein the first PDU set assignment rule comprises a first PDU set importance (PDSI) assignment rule, and wherein the second PDU set assignment rule comprises a second PDU set importance (PDSI) assignment rule, and wherein the first PDU set base value comprises a first PDSI base value, and wherein the second PDU set base value comprises a second PDSI base value.

22. A method for a first network node, the method comprising:
detecting a triggering event;
sending, to a first wireless transmit receive unit (WTRU), a first message, wherein the first message comprises a first protocol data unit (PDU) set assignment rule, and wherein the first PDU set assignment rule corresponds to a quality of service (QoS) flow, and wherein the first PDU set assignment rule indicates a first PDU set base value and a discard factor;
sending, to a second network node, a second message, wherein the second message comprises a second PDU set assignment rule, and wherein the second PDU set assignment is associated with the QoS flow, and wherein the second PDU set assignment rule indicates a second PDU set base value; and
sending, to a third network node, a third message, wherein the third message comprises a QoS profile, and wherein the QoS profile indicates the discard factor, and wherein the discard factor corresponds to the QoS flow.

23. The method of claim 22, wherein the second PDU set assignment rule comprises a PDU set reset trigger, and wherein the PDU set reset trigger indicates a condition, and wherein the method further comprises:
based on the condition being satisfied, assigning the second PDU set base value as the PDU set value of a downlink PDU.

24. The method of claim 22, wherein the first PDU set assignment rule comprises a PDU set reset trigger, and wherein the PDU set reset trigger indicates a condition, and wherein the method further comprises:
based on the condition being satisfied, assigning the first PDU set base value as the PDU set value of a downlink PDU.

25. The method of claim 22, wherein the triggering event is associated with one or more of a PDU session establishment request, a PDU session modification request, or receiving policy and charging control (PCC) rules.

26. The method of claim 22, wherein the first network node comprises a session management function (SMF), and wherein the second network node comprises a user plane function (UPF), and wherein the third network node comprises a radio access network (RAN) node.

27. The method of claim 22, wherein the first message comprises a non-access stratum (NAS) message, and wherein the NAS message corresponds to one or more of a PDU session establishment accept message or a PDU session modification command message.

28. The method of claim 22, wherein the first PDU set assignment rule comprises a first PDU set importance (PDSI) assignment rule, and wherein the second PDU set assignment rule comprises a second PDU set importance (PDSI) assignment rule, and wherein the first PDU set base value comprises a first PDSI base value, and wherein the second PDU set base value comprises a second PDSI base value.
